(19) United States
(12) Patent Application Publication
(10) Pub. No.: US 2015/0258619 A1
(43) Pub. Date: Sep. 17, 2015

(54) CUTTING TOOL

(71) Applicant: CHERVON INTELLECTUAL PROPERTY LIMITED, Road Town (VG)

(72) Inventors: Zhifeng Chen, Nanjing (CN); Kun Zhu, Nanjing (CN)

(21) Appl. No.: 14/658,677

(22) Filed: Mar. 16, 2015

(30) Foreign Application Priority Data
Mar. 17, 2014 (CN) 201410097654.0
Mar. 17, 2014 (CN) 201420121003.6

(51) Int. Cl. B23D 45/14; B23D 45/04

(52) U.S. Cl. CPC B23D 45/14; B23D 45/044

(57) ABSTRACT

A cutting tool includes a base assembly and a cutting head. The base assembly has a base member and a rotating support. The cutting head has a cutting member, a motor for driving the cutting member, and a head housing comprising a boosting sleeve. The boosting sleeve defines a sleeve cavity for accommodating a spring member arranged between the cutting head and the rotating support. The spring is provided to assist a user in moving the cutting head relative to the base.

This application claims the benefit of CN 201410097654.0, filed on Mar. 17, 2014, and CN 201420121003.6, filed on Mar. 17, 2014, the disclosures of which are incorporated herein by reference in their entirety.

### FIELD OF THE DISCLOSURE

The present disclosure relates generally to cutting tools, and more particularly to miter saws.

### BACKGROUND OF THE DISCLOSURE

Generally, a cutting head of a cutting tool rotatably connects with the base for changing cutting depth. Cutting depth of the saw changes with the working head rotation position.

At the end of the cutting process, user should put up the working head. But, the working head comprises a motor and a transmission mechanism, and it is very hard to put up the working head owing to the heavy weight.

The statements in this section merely provide background information related to the present disclosure and may not constitute prior art.

### SUMMARY

The disclosure describes a cutting tool, comprising: a base assembly and a cutting head; wherein the base assembly comprises: a base member and a rotating support; wherein the cutting head comprises: a cutting member; a motor for driving the cutting member; and a head housing comprising a boosting sleeve; the boosting sleeve defines a sleeve cavity for accommodating a spring member arranged between the cutting head and the rotating support; the cutting head rotatably connects with the rotating support about a rotation axis and has a first rotation position, a second rotation position and a middle rotation position which is between the first rotation position and the second rotation position; when the cutting head is in the first rotation position, the spring member bends in a first direction; when the cutting head is in the second rotation position, the spring member bends in a second direction which is different from the first direction.

Furthermore, when the cutting head is in the middle rotation position, the spring member may extend in a line.

Furthermore, when the cutting head is in the middle rotation position, the gravity center of the cutting head may be in the highest position relative to the rotation axis of the cutting head.

Furthermore, when the cutting head is in the middle rotation position, the gravity center of the cutting head may be in the farthest position relative to the rotation axis of the cutting head.

Furthermore, when the cutting head is in the middle rotation position and the rotation axis is parallel to the horizontal plane, the gravity center of the cutting head may be in a position right above the rotation axis.

Furthermore, when the cutting head is in the first rotation position, the spring member may have a first compression length; when the cutting head is in the second rotation position, the spring member may have a second compression length; when the cutting head is in the middle rotation position, the spring member may have a middle compression length; wherein the first compression length is greater than the second compression length; wherein the middle compression length is less than the first compression length and is greater than the second compression length.

Furthermore, the spring member may bend synchronously with the rotation of the cutting head.

Furthermore, the angular value associated with the cutting head rotating from the first position to the middle position may be less than the angular value associated with the cutting head rotating from the second position to the middle position.

Furthermore, the angular value associated with the cutting head rotating from the first position to the middle position may be from about 22 degrees to about 25 degrees and the angular value associated with the cutting head rotating from the second position to the middle position may be from about 25 degrees to about 30 degrees.

Furthermore, the angular value associated with the cutting head rotating from the first position to the middle position may be about 22 degrees and the angular value associated with the cutting head rotating from the second position to the middle position may be about 28 degrees.

Furthermore, the cutting tool may comprise a supporting tray for supporting the bottom end of the spring member, wherein the supporting tray fixedly connects with the rotation support.

Furthermore, the cutting tool may comprise a limiting pin for limiting the bottom portion of the spring member, wherein the spring member is a helical spring and the top end of the limiting pin is arranged in the helical spring.

The disclosure also describes a miter saw, comprising: a base assembly and a cutting head; wherein the base assembly comprises: a base member and a rotating support; wherein the cutting head comprises: a cutting member; a motor for driving the cutting member; and a head housing comprising a boosting sleeve; the boosting sleeve defines a sleeve cavity for accommodating a spring member arranged between the cutting head and the rotating support; the cutting head rotatably connects with the rotating support about a rotation axis and has a first rotation position, a second rotation position and a middle rotation position which is between the first rotation position and the second rotation position; when the cutting head is in the first rotation position, the spring member bends in a first direction; when the cutting head is in the second rotation position, the spring member bends in a second direction which is different from the first direction.

Furthermore, when the cutting head is in the middle rotation position, the spring member may extend in a line.

Furthermore, when the cutting head is in the middle rotation position, the gravity center of the cutting head may be in the highest position relative to the rotation axis of the cutting head.

Furthermore, when the cutting head is in the middle rotation position, the gravity center of the cutting head may be in the farthest position relative to the rotation axis of the cutting head.

Furthermore, when the cutting head is in the middle rotation position and the rotation axis is parallel to the horizontal plane, the gravity center of the cutting head may be in a position right above the rotation axis.

Furthermore, when the cutting head is in the first rotation position, the spring member may have a first compression length; when the cutting head is in the second rotation position, the spring member may have a second compression length; when the cutting head is in the middle rotation position, the spring member may have a middle compression length; wherein the first compression length is greater than the second compression length; wherein the middle compression length is less than the first compression length and is greater than the second compression length.

Furthermore, the spring member may bend synchronously with the rotation of the cutting head.

Furthermore, the angular value associated with the cutting head rotating from the first position to the middle position may be less than the angular value associated with the cutting head rotating from the second position to the middle position.

### BRIEF DESCRIPTION OF THE DRAWINGS

FIG. 1 is a structure schematic view of a working head of a cutting tool according to the present disclosure in a first position;

FIG. 2 is a structure schematic view of the working head of a cutting tool in a second position;

FIG. 3 is a structure schematic view of the working head of a cutting tool in a middle position;

FIG. 4 is a structure schematic view of the base assembly and locating assembly of a cutting tool;

FIG. 5 is a partial enlarged structure schematic view of the working head of a cutting tool in the first position;

FIG. 6 is a partial enlarged structure schematic view of the working head of a cutting tool in the second position;

FIG. 7 is a partial enlarged structure schematic view of the working head of a cutting tool in the middle position.

The drawings are for illustrative purposes only of exemplary embodiments and not all possible implementations, and are not intended to limit the scope of the present disclosure. Corresponding reference numerals indicate corresponding parts throughout the several views of the drawings.

### DETAILED DESCRIPTION

The following description of the preferred embodiments is merely exemplary in nature and is in no way intended to limit the invention, its application, or uses.

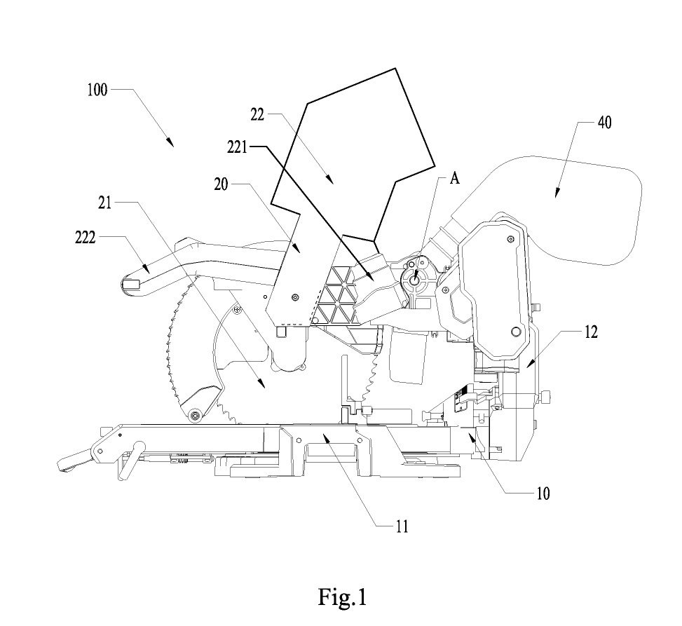

The cutting tool 100 as shown in FIGS. 1-7 may include: a base assembly 10, a cutting head 20 and a locating assembly 30.

Preferably, the cutting tool 100 is a miter saw.

The base assembly 10 may include: a base member 11 and a rotating support 12. The rotating support 12 is arrange on the base member 11.

Specifically, the base member 11 is arranged to support the cutting tool 100 and locate the timber to be cut, and rotating support 12 may be arranged to connect with the cutting head 20, the dust box 40 and so on. The rotating support 12 may rotatably connect with the base member 11 about a horizontal axis.

The cutting head 20 may include: a cutting member 21 and a head housing 22. The cutting member 21 is rotatably or slidably connected with the head housing 22.

Specifically, as shown in FIGS. 1-5, the cutting member 21 preferably is a circular saw blade and is capable of rotating to cut. Certainly the cutting member 21 also may be another kind of saw blade and may be capable of moving in a straight line or a curved line.

The head housing 22 may accommodate a motor and a transmission mechanism, etc. The cutting head 20 is a whole body when it rotates. Furthermore, the head housing 22 forms a handle portion 222.

The head housing 22 include a boosting sleeve 221 which has a sleeve cavity for accommodating a spring member 50. The spring member 50 is arranged to provide support between the cutting head 20 and the rotating support 12.

Specifically, the top end of spring member 50 supports the closed end of the boosting sleeve 221, and a portion of the rotating support 12 supports the bottom end of the spring member 50.

The cutting head 20 rotatably connects with the rotating support 12 about a rotation axis A and has a first rotation position, a second rotation position and a middle rotation position. The middle rotation is between the first rotation position and the second rotation position.

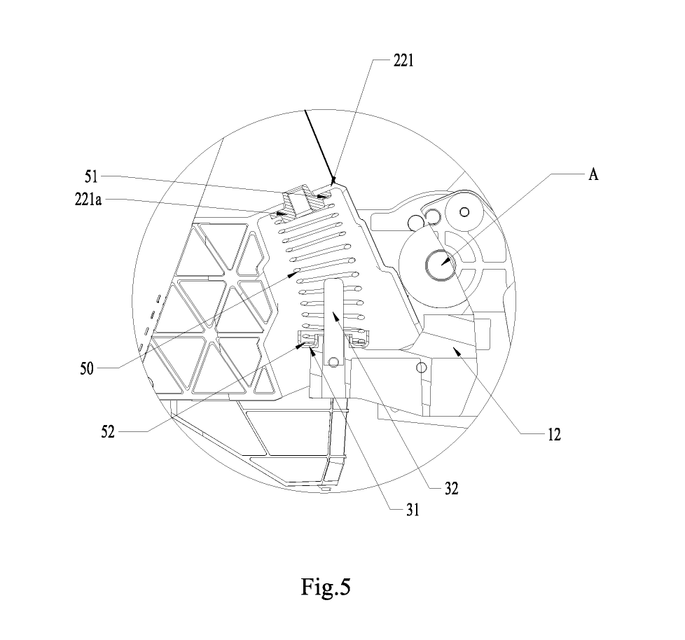

As shown in FIGS. 1 and 5, when the cutting head 20 is in the first rotation position, the spring member 50 bends in a first direction.

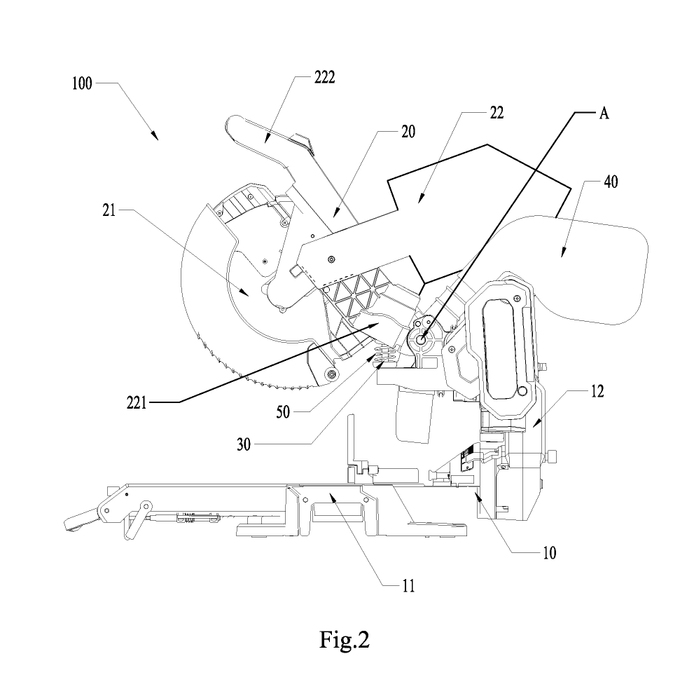

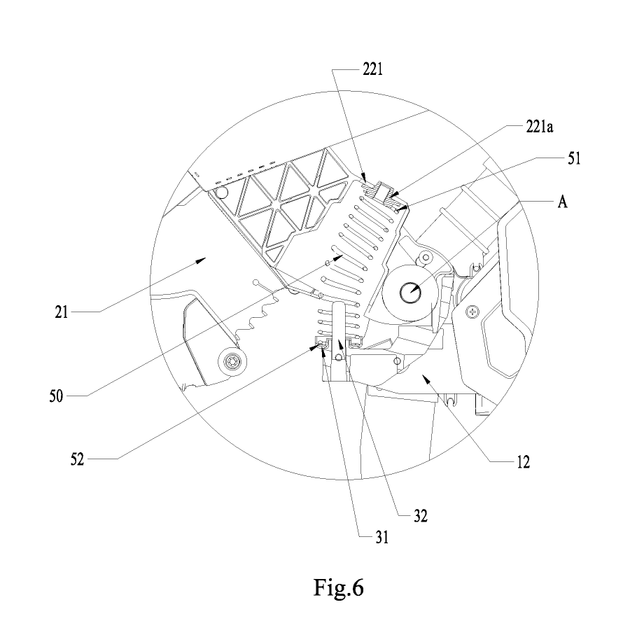

As shown in FIGS. 2 and 6, when the cutting head 20 is in the second rotation position, the spring member 50 bends in a second direction which is different from the first direction.

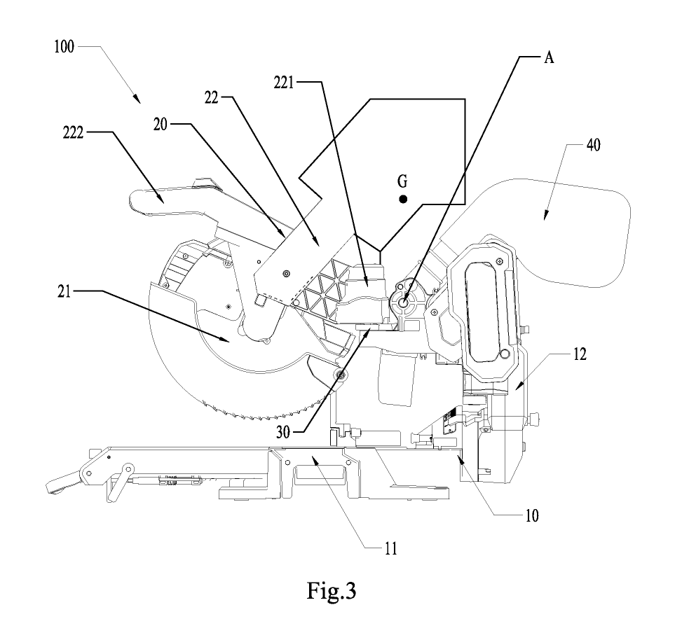

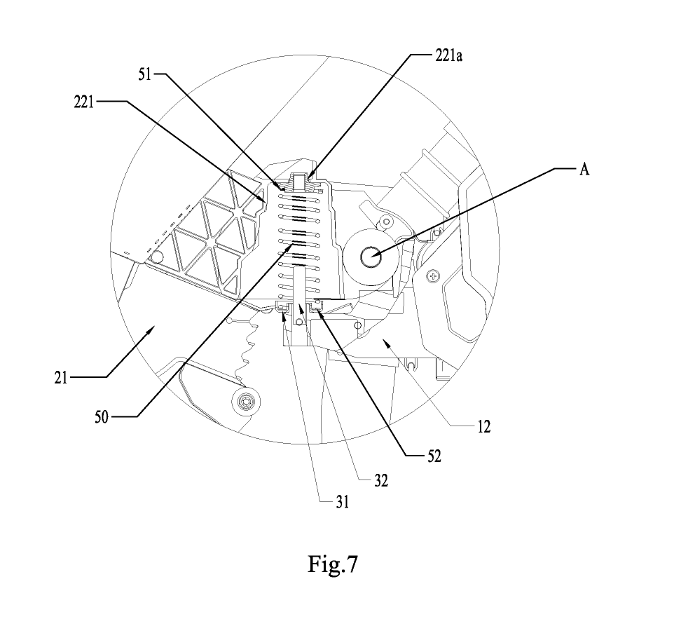

As shown in FIGS. 3 and 7, when the cutting head 20 is in the middle rotation position, the spring member 50 extends in a line. Preferably, the spring member 50 is a helical spring which includes a top support ring 51 and a bottom ring 52. Spring member 50 extending in a line specifically means the axis of top support ring 51 and axis of bottom support ring 52 are all, in the illustrated example, perpendicular to the horizontal plane, e.g., the spring member 50 is shown to extend in a vertical line.

As shown in FIGS. 3 and 7, when the cutting head 20 is in the middle rotation position, the gravity center G of the cutting head 20 is in the highest position and in the farthest position relative to the rotation axis A of the cutting head 20.

Furthermore, as shown in FIGS. 3 and 7, when the cutting head 20 is in the middle rotation position and the rotation axis A is parallel to the horizontal plane, the gravity center G of the cutting head 20 is in a position right above the rotation axis A.

As shown in FIGS. 3 and 7, when the cutting head 20 is in the middle rotation position and the rotation axis is parallel to the horizontal plane, the gravity center of the cutting head 20 is in a position right above the rotation axis.

As shown in FIGS. 1-3 and 5-7, when the cutting head 20 is in the first rotation position, the spring member 50 has a first compression length; when the cutting head 20 is in the second rotation position, the spring member 50 has a second compression length; when the cutting head 20 is in the middle rotation position, the spring member 50 has a middle compression length.

The first compression length is greater than the second compression length; and the middle compression length is less than the first compression length and is greater than the second compression length.

As shown in FIGS. 1-3 and 5-7, when the cutting head 20 rotates from the first position to the second position, the spring member bends synchronously with the rotation of the cutting head 20.

Specifically, when the cutting head 20 rotates from the first position to the second position, the top ring 51 rotates a same angular value as the cutting head 20 rotates.

As shown in FIGS. 1-3 and 5-7, the angular value of the cutting head 20 as the cutting head 20 rotates from the first position to the middle position is less than the angular value of the cutting head 20 as the cutting head 20 rotates from the second position to the middle position.

Specifically, the angular value associated with the cutting head 20 rotating from the first position to the middle position is from about 22 degrees to about 25 degrees, preferably 22 degrees; and the angular value associated with the cutting head 20 rotating from the second position to the middle position is from about 25 degrees to about 30 degrees, preferably 28 degrees.

As shown in FIGS. 1-3 and 5-7, when the cutting head 20 rotates from the first position to the middle position and when the cutting head 20 rotates from the second position to the middle position, the energy generated by compressing and bending the spring member 50 functions to provide a lifting force upon the cutting head 20 so as to help the users lift the cutting head 20.

When the cutting head 20 rotates from the middle position to the first position and the cutting head 20 rotates from the middle position to the second position, gravity urges the cutting head 20 downward to help the cutting head 20 rotate downward.

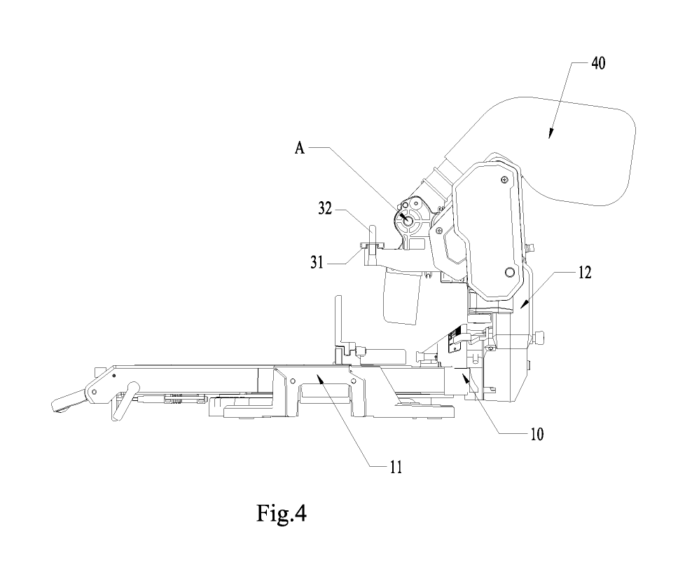

As shown in FIGS. 4-7, the locating assembly 30 may include a supporting tray 31 for supporting the bottom end of the spring member 50 and the supporting tray 31 fixedly connects with the rotation support 12.

The locating assembly 30 may also include a limiting pin 32 for limiting the bottom portion of the spring member 50, and the top end of limiting pin 32 is arranged in the spring member 50.

As shown in FIGS. 4-7, the boosting sleeve has a disc member 221a in the top portion of the sleeve cavity which is arranged to contact with the spring member 50.

The above illustrates and describes basic principles, main features and advantages of the present invention. Those skilled in the art should appreciate that the above embodiments do not limit the present invention in any form. Technical solutions obtained by equivalent substitution or equivalent variations all fall within the scope of the present invention.

What is claimed is:

1. A cutting tool, comprising:
a base assembly; and
a cutting head;
wherein the base assembly comprises a base member and a rotating support;
wherein the cutting head comprises a cutting member, a motor for driving the cutting member, and a head housing comprising a boosting sleeve;
wherein the boosting sleeve defines a sleeve cavity for accommodating a spring member arranged between the cutting head and the rotating support;
wherein the cutting head rotatably connects with the rotating support about a rotation axis and has a first rotation position, a second rotation position, and a middle rotation position which is between the first rotation position and the second rotation position; and
wherein, when the cutting head is in the first rotation position, the spring member bends in a first direction and, when the cutting head is in the second rotation position, the spring member bends in a second direction which is different from the first direction.

2. The cutting tool according to claim 1, wherein, when the cutting head is in the middle rotation position, the spring member extends in a line.

3. The cutting tool according to claim 1, wherein, when the cutting head is in the middle rotation position, the gravity center of the cutting head is in the highest position relative to the rotation axis of the cutting head.

4. The cutting tool according to claim 1, wherein, when the cutting head is in the middle rotation position, the gravity center of the cutting head is in the farthest position relative to the rotation axis of the cutting head.

5. The cutting tool according to claim 1, wherein, when the cutting head is in the middle rotation position and the rotation axis is parallel to the horizontal plane, the gravity center of the cutting head is in a position directly above the rotation axis.

6. The cutting tool according to claim 1, wherein, when the cutting head is in the first rotation position, the spring member has a first compression length, when the cutting head is in the second rotation position, the spring member has a second compression length, and when the cutting head is in the middle rotation position, the spring member has a middle compression length with the first compression length being greater than the second compression length and the middle compression length being less than the first compression length and greater than the second compression length.

7. The cutting tool according to claim 1, wherein the spring member bends synchronously with the cutting head as the cutting head is rotated.

8. The cutting tool according to claim 1, wherein an angular value associated with the cutting head rotating from the first position to the middle position is less than an angular value associated with the cutting head rotating from the second position to the middle position.

9. The cutting tool according to claim 1, wherein an angular value associated with the cutting head rotating from the first position to the middle position is from about 22 degrees to about 25 degrees and wherein an angular value associated of the cutting head rotating from the second position to the middle position is from about 25 degrees to about 30 degrees.

10. The cutting tool according to claim 1, wherein an angular value associated with the cutting head rotating from the first position to the middle position is about 22 degrees and an angular value associated with the cutting head rotating from the second position to the middle position is about 28 degrees.

11. The cutting tool according to claim 1, further comprising a supporting tray for supporting the bottom end of the spring member, the supporting tray being fixedly connected with the rotation support.

12. The cutting tool according to claim 11, further comprising a limiting pin for limiting the bottom portion of the spring member wherein the spring member is a helical spring, and a top end of the limiting pin is arranged in the helical spring.

13. A miter saw, comprising:
a base assembly; and
a cutting head;
wherein the base assembly comprises a base member and a rotating support;
wherein the cutting head comprises a cutting member, a motor for driving the cutting member, and a head housing comprising a boosting sleeve;
wherein the boosting sleeve defines a sleeve cavity for accommodating a spring member arranged to support between the cutting head and the rotating support;
wherein the cutting head rotatably connects with the rotating support about a rotation axis and has a first rotation position, a second rotation position and a middle rotation position which is between the first rotation position and the second rotation position;
wherein, when the cutting head is in the first rotation position, the spring member bends in a first direction and, when the cutting head is in the second rotation position, the spring member bends in a second direction which is different from the first direction.

14. The miter saw according to claim 13, wherein, when the cutting head is in the middle rotation position, the spring member extends in a line.

15. The miter saw according to claim 13, wherein, when the cutting head is in the middle rotation position, the gravity center of the cutting head is in the highest position relative to the rotation axis of the cutting head.

16. The miter saw according to claim 13, wherein, when the cutting head is in the middle rotation position, the gravity center of the cutting head is in the farthest position relative to the rotation axis of the cutting head.

17. The miter saw according to claim 13, wherein, when the cutting head is in the middle rotation position and the rotation axis is parallel to the horizontal plane, the gravity center of the cutting head is in a position directly above the rotation axis.

18. The miter saw according to claim 13, wherein, when the cutting head is in the first rotation position, the spring member has a first compression length, when the cutting head is in the second rotation position, the spring member has a second compression length, and when the cutting head is in the middle rotation position, the spring member has a middle compression length with the first compression length being greater than the second compression length and the middle compression length being less than the first compression length and greater than the second compression length.

19. The miter saw according to claim 13, wherein the spring member bends synchronously with the cutting head as the cutting head is rotated.

20. The miter saw according to claim 13, wherein the angular value associated with the cutting head rotating from the first position to the middle position is less than the angular value associated with the cutting head rotating from the second position to the middle position.
